(19) United States
(12) Patent Application Publication
(10) Pub. No.: US 2019/0272512 A1
(43) Pub. Date: Sep. 5, 2019

(54) SYSTEMS AND METHODS FOR PROVIDING AN ELECTRONIC LINE-OF-BUSINESS GATEWAY

(71) Applicant: Capital One Services, LLC, McLean, VA (US)

(72) Inventors: Vipin DWIVEDI, Frisco, TX (US); Shilpa MITTAL, Plano, TX (US); Liju MATHEWS, Plano, TX (US); Sahul Peer MOHAMMED, Frisco, TX (US); Amit Ramesh DESHPANDE, McKinney, TX (US)

(73) Assignee: Capital One Services, LLC, McLean, VA (US)

(21) Appl. No.: 15/910,208

(22) Filed: Mar. 2, 2018

(51) Int. Cl. G06Q 20/08; G06N 99/00; G06F 17/30

(52) U.S. Cl. CPC G06Q 20/08; G06F 17/30657; G06N 99/005

(57) ABSTRACT

Disclosed embodiments provide systems and methods for providing an electronic line-of-business gateway. In some embodiments, systems and methods may acquire data representing an offer, the data comprising an offer attribute and being associated with a producer device. In certain embodiments, systems and methods may generate a business context attribute based on the offer attribute. Additionally, in some embodiments, systems and methods may generate a data structure based on the offer attribute and the business context attribute, the data structure having a field. Moreover, in certain embodiments, systems and methods may generate an index for the field. Further, in some embodiments, systems and methods may store, based on the index, the field into the database.

### TECHNICAL FIELD

This disclosure generally relates to big data analytics, and more particularly, line-of-business applications utilizing big data analytics.

### BACKGROUND

Many large corporations have multiple business units. A business unit is often a relatively autonomous division of a large corporation that operates an independent enterprise with responsibility for a particular line of business (e.g., a particular range of products or activities). Because a business unit is relatively autonomous, it often uses a relatively autonomous enterprise software platform to provide services to any users for its particular line of business. As expected, this enterprise software platform is commonly referred to as a line-of-business application.

Line-of-business applications often rely on database management systems to manage “big data,” that is, large and complex collections of data, in order to conduct services associated with these lines of business. While relatively autonomous, the big data of a business unit can often overlap significantly with the big data of another business unit. Because of their autonomy, business units often do not have access to the “big data” of other business units and large amounts of data are often copied. Moreover, valuable insights between the big data within multiple business units cannot be utilized.

Even further, line-of-business applications are programmed customarily using vastly different and complex software solutions. Thus, programming a new or existing line-of-business application to communicate and share big data with another line of business often costs enormous amounts of money, time, and effort, and introduces many risks with respect to the business unit's ability to serve its customers at a consistent and high level.

In view of these and other shortcomings and problems with line-of-business applications within large corporations, novel systems and techniques are provided for sharing data between line-of-business applications. The novel systems and techniques are also designed to be easily integrated within new or existing line-of-business applications to mitigate costs and risks associated with a line-of-business.

### SUMMARY

The present invention addresses the disadvantages of the prior art by providing novel systems, methods, and techniques for providing an electronic line-of-business gateway. Unlike any prior implementations, the disclosed systems and methods improve data quality and big analytics by allowing line-of-business applications to communicate and pass data between one another in real-time. The disclosed systems and methods are also robust and can be integrated into most line-of-business applications. The disclosed systems and methods may accomplish this because the disclosed systems and methods may be constructed in a highly adaptive way, such as using, for example, representation state transfer technology.

To provide these improvements, the disclosed systems and methods may be implemented using a combination of conventional hardware, firmware, and/or software, as well as specialized hardware, firmware, and/or software, such as a machine constructed and/or programmed specifically for performing functions associated with the disclosed method steps. However, in some embodiments, disclosed systems and methods may be implemented instead by dedicated hardware.

Certain disclosed embodiments provide systems for providing an electronic line-of-business gateway. For example, a system may comprise one or more memory devices storing instructions and one or more processors configured to execute instructions to perform operations. The operations may comprise acquiring data representing an offer, the data comprising an offer attribute and being associated with a producer device. The operations may further comprise generating a business context attribute based on the offer attribute. The operations may also comprise generating a data structure based on the offer attribute and the business context attribute, the data structure having a field. Further, the operations may comprise generating an index for the field. In addition, the operations may comprise storing, based on the index, the field into the database.

In addition, certain disclosed embodiments provide methods for providing an electronic line-of-business gateway. For example, the method may comprise acquiring data representing an offer, the data comprising an offer attribute and being associated with a producer device. The method may further comprise generating a business context attribute based on the offer attribute. The method may also comprise generating a data structure based on the offer attribute and the business context attribute, the data structure having a field. Further, the method may comprise generating an index for the field. In addition, the method may comprise storing, based on the index, the field into the database.

Moreover, certain disclosed embodiments provide systems for providing an electronic line-of-business gateway. For example, a system may comprise one or more memory devices storing instructions and one or more processors configured to execute instructions to perform operations. The operations may comprise obtaining, from a first consumer device, a data request to receive data, the data request comprising information associated with a line of business application. The operations may further comprise identifying a plurality of fields associated with the line of business application and a plurality of producer devices. Also, the operations may comprise determining a characteristic associated with the data request to receive data. Further, the operations may comprise analyzing the fields based on the characteristic. The operations may also comprise generating output data based on the analysis, the output data comprising data from a first producer device of the plurality of producer devices and a second producer device. Even further, the operations may comprise sending the output data to the first consumer device.

Additionally, certain disclosed embodiments provide methods for providing an electronic line-of-business gateway. For example, the method may comprise obtaining, from a first consumer device, a data request to receive data, the data request comprising information associated with a line of business application. The method may also comprise identifying a plurality of fields associated with the line of business application. In addition, the method may comprise determining a characteristic associated with the data request to receive data. Further, the method may comprise analyzing the fields based on the characteristic. Even further, the method may comprise generating output data based on the analysis, the output data comprising data from a first producer device and a second producer device. The method may also comprise sending the output data to the first consumer device.

Aspects of the disclosed embodiments may also include a tangible, non-transitory, computer-readable medium that stores software instructions that, when executed by one or more processors, are configured for and capable of performing and executing one or more of the methods, operations, and the like consistent with the disclosed embodiments.

It is to be understood that both the foregoing general description and the following detailed description are exemplary and explanatory only, and are not restrictive of the disclosed embodiments as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system environment for providing an electronic line-of-business gateway in accordance with the disclosed embodiments;

FIG. 2 is a block diagram of exemplary interactions with the electronic line-of-business gateway in accordance with the disclosed embodiments;

FIG. 3 is a block diagram of an exemplary computing device in accordance with the disclosed embodiments;

FIG. 4 is an exemplary electronic line-of-business gateway application in accordance with the disclosed embodiments;

FIG. 5 is a flowchart of an exemplary data handling process in accordance with the disclosed embodiments; and

FIG. 6 is a flowchart of an exemplary data consumption process in accordance with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

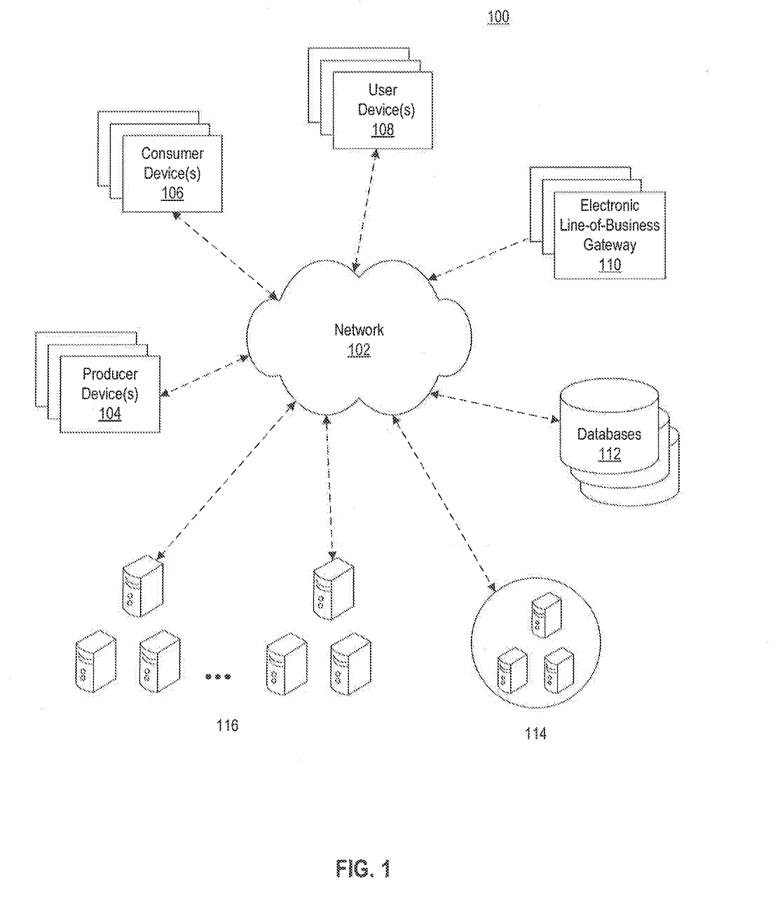

FIG. 1 is a block diagram illustrating exemplary system environment 100 for providing an electronic gateway 110 in accordance with the disclosed embodiments. The components and arrangements shown in FIG. 1 are not intended to limit the disclosed embodiments, as the components used to implement the disclosed processes and features may vary.

System environment 100 may include one or more networks 102, producer device(s) 104, consumer device(s) 106, user device(s) 108, electronic line-of-business gateway(s) 110, database(s) 112, cloud service(s) 114, and server cluster(s) 116. Other components known to one of ordinary skill in the art may be included in system environment 100 to gather, process, transmit, receive, acquire, and provide information used in conjunction with the disclosed embodiments. In addition, system environment 100 may further include other components that perform or assist in the performance of one or more processes that are consistent with the disclosed embodiments.

In some embodiments, system environment 100 may include one or more network(s) 102. Network 102 may comprise any computer networking arrangement used to exchange data. For example, network 102 may be the Internet, a private data network, a virtual private network (VPN) using a public network, and/or other suitable connections that enable the components of system environment 100 to send and acquire information. Network 102 may also include a public switched telephone network (“PSTN”) and/or a wireless network such as a cellular network, wired Wide Area Network, Wi-Fi network, and/or another known wireless network (e.g., WiMAX) capable of bidirectional data transmission.

Network 102 may also include one or more local networks (not pictured). A local network may be used to connect the components of FIG. 1, such as producer device 104, consumer device 106, user device 108, electronic line-of-business gateway(s) 110, database(s) 112, cloud service(s) 114, and server cluster(s) 116 to network 102. A local network may comprise any type of computer networking arrangement used to exchange data in a localized area, such as Wi-Fi based on IEEE 802.11 standards, Bluetooth™, Ethernet, and other suitable network protocols that enable components of system environment 100 to interact with one another and to connect to network 102 for interacting with components in system environment 100. In some embodiments, a local network comprises a portion of network 102. In other embodiments, components of system environment 100 may communicate via network 102 without a separate local network.

In some embodiments, system environment 100 may include one or more producer device(s) 104. Producer device 104 may be a computing system that is associated with a producer (e.g., a merchant) or other business entity such as an insurance company, a healthcare company, a transportation dealer (e.g., an auto dealer, airplane dealer, etc.), a repair shop (e.g., an auto shop, a computer shop, etc.), a market maker, an advertising platform (e.g., on-demand inventory, manufacturer's discounts, etc.), a grocery store, a service provider (e.g., utilities, etc.), or any other type of entity that provides goods and/or services that customers may purchase. Further, producer device 104 is not limited to conducting businesses in any particular industry or field.

Producer device 104 may be associated with a brick-and-mortar location that a user may physically visit to purchase goods and/or services. Such physical locations may include producer devices 104, which may include computing devices that perform financial service transactions with customers (e.g., terminals, kiosks, etc.). Producer device 104 may also include back- and/or front-end computing components that store data and execute software instructions to perform operations consistent with the disclosed embodiments, such as computers that are operated by employees of the producer (e.g., back-office systems, etc.). Producer device 104 may also be associated with a producer that provides goods and/or services via known online or e-commerce type of solutions. For example, such a producer may sell goods via a website using known online or e-commerce systems and solutions to market, sell, and process online transactions. Producer device 104 may host the website to provide the website to users.

In some embodiments, producer device 104 may include one or more servers or another type of computing device configured to execute software instructions stored in memory to perform one or more processes consistent with the disclosed embodiments. For example, producer device 104 may include one or more memory devices storing data and software instructions and one or more processors configured to use the data and execute the software instructions to perform server-based functions and operations known to those skilled in the art. In some embodiments, producer device 104 may have an application installed thereon to perform one or more processes that are consistent with the disclosed embodiments.

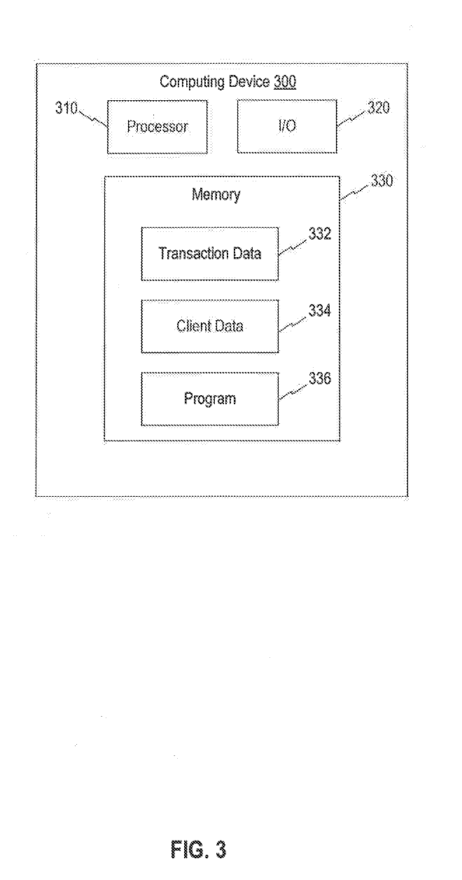

In certain embodiments, producer device 104 may further include servers that are configured to execute stored software instructions to perform operations associated with a producer, including processes associated with handling purchase transactions, generating transaction data, generating product data (e.g., SKU data) relating to purchase transactions, etc. Producer device 104 may include one or more servers that may be a general-purpose computer, a mainframe computer, or any combination of these components. In certain embodiments, producer device 104 (or a system including producer device 104) may be configured as an apparatus, system, and the like based on the storage, execution, and/or implementation of the software instructions that perform one or more operations consistent with the disclosed embodiments. Producer device 104 may be standalone or part of a subsystem included in a larger system. For example, producer device 104 may include distributed servers that are remotely located and communicate over a network (e.g., network 102 or a local network). An exemplary computing device consistent with producer device 104 is discussed in additional detail with respect to FIG. 3.

In some embodiments, system environment 100 may include one or more consumer device(s) 106. Consumer device 106 may be a computing system that is associated with a consumer. A consumer may be a line of business, that is, a consumer may sell one or more goods and/or services from one or more producers. For example, if the consumer is an auto dealer, then the consumer may offer, for example, goods or services (such as car insurance, car repair, vehicles, etc.) from producers (such as car insurance companies, auto body shops, car manufacturers, etc.) to a user. Consumer device 106 may include a line-of-business application that allows a user to complete an entire business process (e.g., buying a car, buying a home, etc.) for a particular line of business (“automobiles,” “real-estate,” etc.). Thus, consumer device 106 may use the application to sell a combination of products and/or services to the user. Further, consumer device 106 is not limited to conducting businesses in any particular industry or field.

Consumer device 106 may be associated with a brick-and-mortar location that a user may physically visit to purchase goods and/or services from a consumer. Such physical locations may include consumer devices 106, which may include computing devices that perform financial service transactions with customers (e.g., terminals, kiosks, etc.). Consumer device 106 may also include back- and/or front-end computing components that store data and execute software instructions to perform operations consistent with the disclosed embodiments, such as computers that are operated by employees of the consumer (e.g., back-office systems, etc.). Consumer device 106 may also be associated with a consumer that provides goods and/or services via known online or e-commerce type of solutions. For example, such a consumer may sell goods via a website using known online or e-commerce systems and solutions to market, sell, and process online transactions. Consumer device 106 may host the website to provide the website to users. Additionally or alternatively, consumer device 106 may be an enterprise line-of-business application. The enterprise line-of-business application may integrate various services together for the consumer and its users.

Consumer device 106 may include one or more servers or another type of computing device configured to execute software instructions stored in memory to perform one or more processes consistent with the disclosed embodiments. For example, consumer device 106 may include one or more memory devices storing data and software instructions and one or more processors configured to use the data and execute the software instructions to perform server-based functions and operations known to those skilled in the art. In some embodiments, consumer device 106 may have an application installed thereon to perform one or more processes that are consistent with the disclosed embodiments.

Consumer device 106 may further include servers that are configured to execute stored software instructions to perform operations associated with a consumer, including processes associated with handling purchase transactions, generating transaction data, generating product data (e.g., SKU data) relating to purchase transactions, etc. Consumer device 106 may include one or more servers that may be a general-purpose computer, a mainframe computer, or any combination of these components. In certain embodiments, consumer device 106 (or a system including consumer device 106) may be configured as an apparatus, system, and the like, based on the storage, execution, and/or implementation of the software instructions that perform one or more operations consistent with the disclosed embodiments. In some embodiments, consumer device 106 may transmit data to one or more user device(s) 108.

Consumer device 106 may be standalone or part of a subsystem included in a larger system. For example, consumer device 106 may include distributed servers that are remotely located and communicate over a network (e.g., network 102 or a local network). An exemplary computing device consistent with consumer device 106 is discussed in additional detail with respect to FIG. 3.

In some embodiments, system environment 100 may include one or more user device(s) 108. User device 108 may be a desktop computer, a laptop, a tablet, a smartphone, a multifunctional watch, a pair of multifunctional glasses, a tracking device, or any suitable device with computing capability. User device 108 may comprise a memory, a processor, and/or other specialized hardware that is configured to execute one or more methods of the disclosed embodiments. User device 108 may have an application installed thereon, which may enable user device 108 to communicate with, for example, producer device 104 and/or consumer device 106 via network 102 and/or local network. Additionally, user device 108 may connect to producer device 104 and/or consumer device 106 through use of web browser software.

User device 108 may also include a GPS unit (not pictured). In some embodiments, user device 108 may use the GPS unit to acquire and transmit the position information, such as the physical location of user device 108, to producer device 104 and/or consumer device 106. An exemplary computing device consistent with user device 108 is discussed in additional detail with respect to FIG. 3. A user may operate user device 108 to perform one or more operations consistent with the disclosed embodiments. In one aspect, a user may be a customer of a business, financial service provider, etc., that may be associated with producer device 104, consumer device 106, and/or electronic line-of-business gateway 110.

In some embodiments, system environment 100 may include one or more electronic line-of-business gateway(s) (“electronic gateway”) 110. Electronic gateway 110 may be implemented using different equipment, such as one or more supercomputers, one or more personal computers, one or more servers (e.g., cloud service 114 and/or server cluster 116), one or more mainframes, one or more mobile devices, or the like. In some embodiments, electronic gateway 110 may comprise hardware, software, and/or firmware modules. Electronic gateway 110 may be utilized and/or be integrated with one or more commercial and/or open source technologies.

Electronic gateway 110 may be configured to acquire, analyze, transform, transmit data, etc., (e.g., data representing goods, services, offers, etc.) between one or more producer device(s) 104 and/or one or more consumer device(s) 106. In some embodiments, electronic gateway 110 may utilize data (e.g., data representing offers, etc.) from one or more producer device(s) 104 to offer customized offers to consumer device(s) 106. Electronic gateway 110 may analyze data from one or more producer device(s) 104 in order to provide the offers to consumer device(s) 106 that fulfill one or more characteristics of consumer device(s) 106. An exemplary computing device consistent with electronic gateway 110 is discussed in additional detail with respect to FIG. 3.

In some embodiments, system environment 100 may include one or more database(s) 112. Database 112 may include one or more memory devices that store information. By way of example, database 112 may include Oracle™ databases, Sybase™ databases, or other relational databases or non-relational databases, such as Hadoop sequence files, HBase™, or Cassandra™. The databases or other files may include, for example, data and information related to the source and destination of a network request, the data contained in the request, etc. Systems and methods of disclosed embodiments, however, are not limited to separate databases. Database 112 may include computing components (e.g., database management system, database server, etc.) configured to acquire and process requests for data stored in memory devices of database 112 and to provide data from database 112.

In some embodiments, system environment 100 may include one or more cloud service(s) 114. Cloud service 114 may include a physical and/or virtual storage system associated with cloud storage for storing data and providing access to data via a public network such as the Internet. Cloud service 114 may include cloud services such as those offered by, for example, Amazon®, Apple®, Cisco®, Citrix®, IBM®, Joyent®, Google®, Microsoft®, Rackspace®, Salesforce.com®, and Verizon®/Terremark®, or other types of cloud services accessible via network 102. In some embodiments, cloud service 114 comprises multiple computer systems spanning multiple locations and having multiple databases or multiple geographic locations associated with a single or multiple cloud storage service(s). As used herein, cloud service 114 refers to physical and virtual infrastructure associated with a single cloud storage service and may manage and/or store data associated with managing tip recommendations.

In some embodiments, system environment 100 may include one or more server cluster(s) 116. Server cluster 116 may be located in the same data center or different physical locations. Multiple server clusters 116 may be formed as a grid to share resources and workloads. Each server cluster 116 may include a plurality of linked nodes operating collaboratively to run various applications, software modules, analytical modules, rule engines, etc. Each node may be implemented using a variety of different equipment, such as a supercomputer, personal computer, a server, a mainframe, a mobile device, or the like. In some embodiments, the number of servers and/or server cluster 150 may be expanded or reduced based on workload. In some embodiments, one or more components of system environment 100 (including one or more server cluster 150) may be placed behind a load balancer to support high availability and ensure real-time (or near real-time) processing of optimal decision predictions.

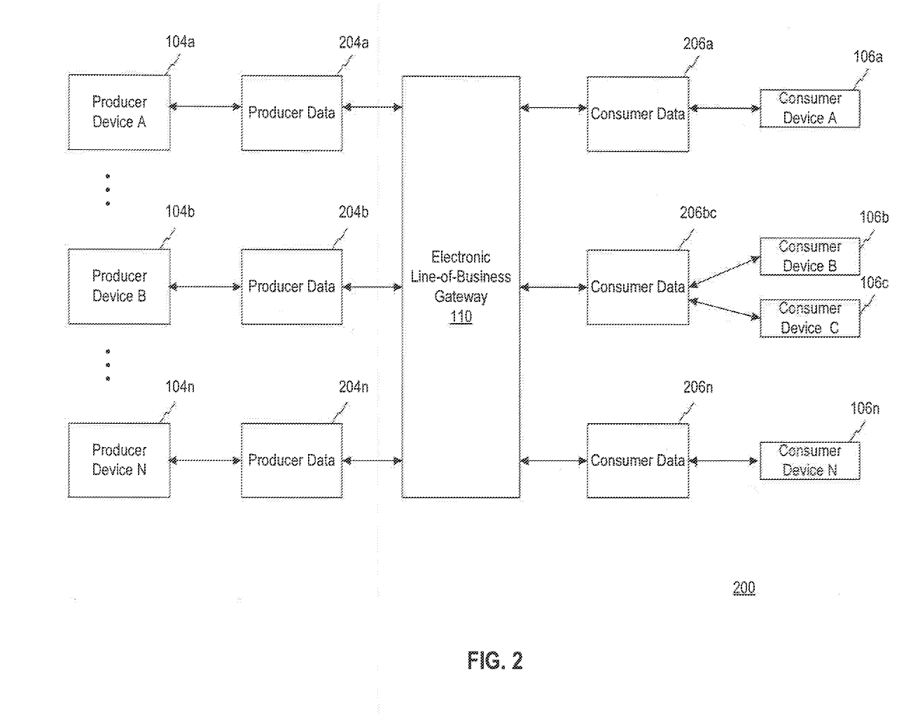

FIG. 2 is a block diagram of exemplary interactions with the electronic line-of-business gateway in accordance with the disclosed embodiments. It should be understood that FIG. 2 is only exemplary and many configurations and/or interactions may be made between components of FIG. 2, such as producer devices 104a-n, producer data 204a-n, electronic line-of-business gateways 110, consumer data 206a-n, and consumer devices 106a-n. In addition, additional components may assist or replace components of FIG. 2 or be positioned between components of FIG. 2. For example, in some embodiments, user devices 108 (not depicted in FIG. 2) may communicate with one or more consumer devices 106 a-n and/or producer devices 104 a-n.

As shown in FIG. 2, one or more producer devices (e.g., producer devices 104a-n) may send producer data 204a-n to and receive producer data 204a-n from electronic gateway 110. In addition, one or more consumer devices 106a-n may send consumer data 206a-n to and receive consumer data 206a-n from electronic gateway 110. Each of producer devices 104a-n may be associated with one or more merchants. Producer devices 104a-n may provide different goods or services. For example, in one embodiment, producer device 104a may provide a good, producer device 104b may provide insurance for the good, etc.

Each producer device 104a-n may send producer data 204a-n to or receive producer data 204a-n from electronic gateway 110. When electronic gateway 110 receives producer data 204a-n from a producer device 104a-n, the producer data 204a-n may be referred to as “incoming producer data.” Incoming producer data may include data that represents an offer to enter into a contractual relationship with a user. Incoming producer data may include the terms of an offer, full-text of the offer, discounts, and/or promotions related to the offer, an address (e.g., an internet address) to the offer, an address to accept or deny the offer, date of an offer, expiration of an offer, a producer identifier, and/or any information related to a producer device 104a-n, electronic gateway 110, and/or a consumer device 106a-n. When electronic gateway 110 sends producer data 204a-n to a producer device 104a-n, the producer data 204a-n may be referred to as “outgoing producer data.” Outgoing producer data may include one or more notifications, such as a notification to inform a producer device 104a-n that the producer data 204a-n has been downloaded, stored, updated, deleted, and/or any information related to a producer device 104a-n, electronic gateway 110, and/or a consumer 106a-n device from electronic gateway 110.

Each of consumer devices 106a-n may be associated with one or more merchants, line of businesses, and/or line-of-business applications. Consumer devices 106a-n may be associated with different lines of businesses. For example, in one embodiment, consumer device 106a may be associated with the auto industry, consumer device 106b may be associated with the real-estate industry, and consumer device 106c may be associated with the healthcare industry.

Each consumer device 106a-n may send consumer data 206a-n to or receive consumer data from electronic gateway 110. When electronic gateway 110 receives consumer data 206a-n from a consumer device 106a-n, the consumer data 206a-n may be referred to as “incoming consumer data.” Incoming consumer data may be associated with a particular line of business (e.g., the line of business of a consumer device 106a-n). Incoming consumer data, a characteristic (e.g., any information relating to a requirement of a consumer device 106a-n, a requirement of a line of business associated with a consumer device 106a-n, user information associated with a consumer device 106a-n, user device information associated with a consumer device 106a-n, etc.), a consumer identifier, an expiration date of a request to obtain data, an address (e.g., an Internet address) associated with a consumer device 106a-n, and/or any information related to a producer device 104a-n, electronic gateway 110, and/or a consumer device 106a-n.

When electronic gateway 110 sends consumer data 206a-n to a consumer device 106a-n, the consumer data 206a-n may be referred to as “outgoing consumer data.” Outgoing consumer data may include one or more notifications, such as a notification to inform a consumer device 106a-n that the consumer data 206a-n has been downloaded, stored, updated, deleted, etc., from electronic gateway 110. Outgoing consumer data may, additionally or alternatively, include output data, for example, data that electronic gateway 110 has determined to satisfy one or more characteristics). Outgoing consumer data may also include data, such as a producer identifier, an offer identifier, an offer, the full-text of an offer, a formatted text of an offer, and/or any information related to a producer device 104a-n, electronic gateway 110, and/or a consumer device 106a-n. In some embodiments, outgoing consumer data may comprise some or all of a plurality of producer data 204a-n (e.g., consumer data 206a may comprise some or all of producer data 204a and/or some or all of producer data 204b). Moreover, in some embodiments, electronic gateway 110 may send the same outgoing consumer data to two different consumer devices (e.g., consumer data 206bc may be sent to consumer device 106b and consumer device 106c).

FIG. 3 is a block diagram of an exemplary computing device 300 in accordance with the disclosed embodiments. As shown, computing device 300 may include one or more processor(s) 310, one or more input/output (“I/O”) device(s) 320, and one or more memory device(s) 330. Memory 330 may store data, including transaction data 332 and other data 334. Memory 330 may also include one or more program(s) 336. Computing device 300 may be implemented in a single server or in a distributed computer system including multiple servers or computers (e.g., cloud service 114 and/or server clusters 116) that interoperate to perform one or more of the processes and functionalities associated with the disclosed embodiments. In some embodiments, computing device 300 is specially configured with hardware and/or software modules for performing functions of the disclosed methods. The components of computing system 300 may be implemented as specialized circuitry integrated within processor 310 or in communication with processor 310, and/or as specialized software stored in memory 330 executable by processor 310.

Processor 310 may be implemented as one or more known or custom processing devices designed to perform functions of the disclosed methods, such as single- or multiple-core processors capable of executing parallel processes simultaneously to allow computing device 300 to execute multiple processes simultaneously. For example, processor 310 may be configured with virtual processing technologies. Processor 310 may implement virtual machine technologies, including a Java virtual machine, or other known technologies to provide the ability to execute, control, run, manipulate, store, etc., multiple software processes, applications, programs, etc. One of ordinary skill in the art would understand that other types of processor arrangements could be implemented that provide for the capabilities disclosed herein.

I/O device 320 may comprise one or more interfaces for receiving input signals from other devices and for providing output signals to other devices to allow data to be received and/or transmitted by computing device 300. I/O device 320 may also include interface components that display information and/or provide interfaces to one or more input devices, such as one or more keyboards, mouse devices, and the like, to enable computing device 300 to receive input from a user (not shown).

Memory 330 may include instructions to enable processor 310 to execute programs 336, such as one or more operating systems, server applications, network communication processes, and any other type of application or software known to be available on computer systems. Alternatively or additionally, instructions may be stored in remote storage (not shown) in communication with computing device 300, such as one or more database or memory modules accessible over network 102. The internal database and external storage may be implemented in volatile or non-volatile, magnetic, semiconductor, tape, optical, removable, non-removable, or another type of storage device or tangible (i.e., non-transitory) computer-readable medium.

The remote storage may be configured to store information (e.g., structured, semi-structured, and/or unstructured data) and may be accessed and/or managed by computing device 300. By way of example, the remote storage may be implemented as databases, such as Microsoft® SQL databases, SharePoint™ databases, Oracle® databases, Sybase™ databases, or other databases. Systems and methods consistent with the disclosed embodiments, however, are not limited to separate databases or even to the use of a database.

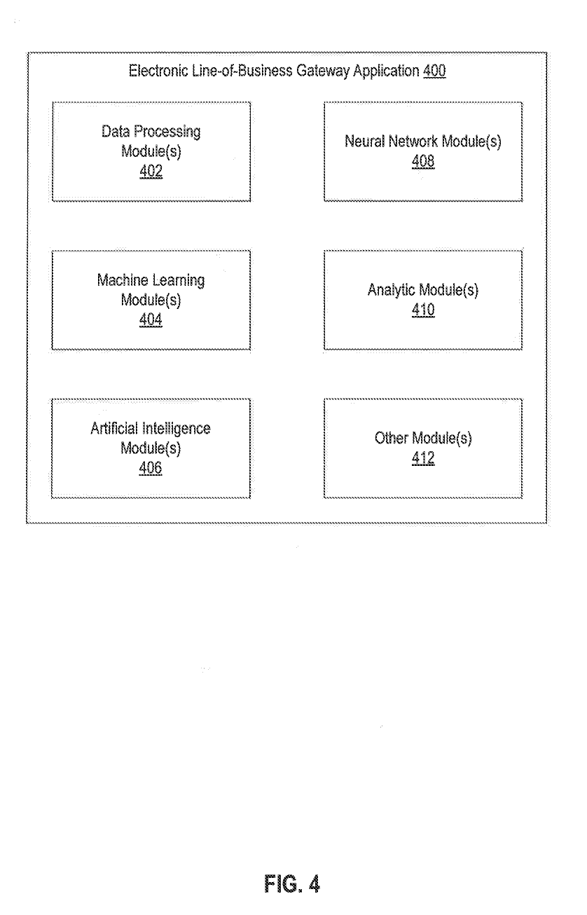

In some embodiments, computing device 300 may include memory 330 that includes instructions that, when executed by processor 310, perform one or more processes consistent with the functionalities disclosed herein. Methods, systems, and articles of manufacture consistent with the disclosed embodiments are not limited to separate programs or computers configured to perform dedicated tasks. For example, computing device 300 may include memory 330 that may include one or more programs 336 and/or gateway application 400, as described in FIG. 4, to perform one or more functions of the disclosed embodiments. Moreover, processor 310 may execute one or more programs located remotely from system environment 100. For example, computing device 300 may access one or more remote programs, that, when executed, perform functions related to disclosed embodiments.

Programs 336 may also include one or more machine learning, trending, and/or pattern recognition applications (not shown) that cause processor 310 to execute one or more processes related to providing an electronic line-of-business gateway. For example, the machine learning, trending, and/or pattern recognition may provide, modify, or suggest input variables associated with one or more other programs 336. Program 336 may include, for example, operating system and gateway application. Programs 336 may be implemented or integrated using one or more commercial and/or open sourced platforms, such as Chassis™, PostgreSQL™, Apache Kafka™, Open NLP™, Spark™, Amazon Web Services™, Docker™, Jenkins™, HTML™, CSS™, Less™, AngularJS™, etc.

FIG. 4 is an exemplary electronic line-of-business gateway application 400 in accordance with the disclosed embodiments. Electronic line-of-business gateway application 400 may include components, such as one or more data processing module(s) 402, machine learning module(s) 404, artificial intelligence module(s) 406, neural network module(s) 408, analytic module(s) 410, and/or other module(s) 412. Various components of gateway application 400 may be used in the disclosed embodiments. Electronic line-of-business gateway application 400 may be constructed in a highly adaptive way, such as using, for example, representation state transfer technology.

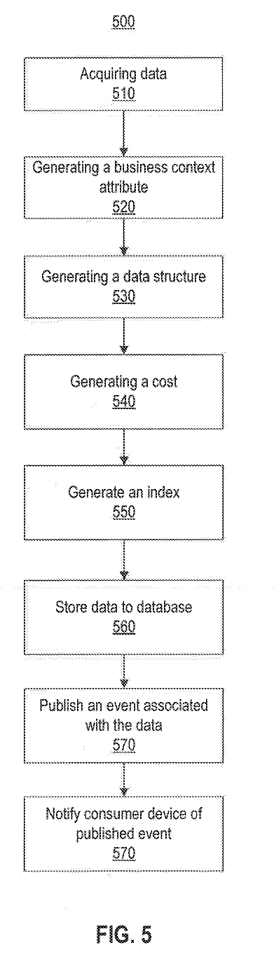

FIG. 5 is a flowchart illustrating an exemplary data handling process 500 in accordance with the disclosed embodiments. Electronic gateway 110 via electronic line-of-business application 400 may implement one or more steps in the flowchart. However, the steps illustrated in the flowchart are only exemplary. One or more steps may be added or deleted to implement data handling process 500.

At step 510, electronic gateway 110 may acquire data (e.g., producer data) associated with one or more producer device(s) 104. As described above, the data may represent an offer to enter into a contractual relationship with a user, such as a user who is associated with user device 108.

For example, in some embodiments, electronic gateway 110 may scrape data from one or more addresses (e.g., an internet address) to acquire the data. In some embodiments, the address may be associated with a producer, producer device 104, and/or the offer. Electronic gateway 110 may receive the address from an API, a third-party device, producer device 104, consumer device 106, user device 108, etc. In some embodiments, electronic gateway 110 may query the address via, for example, network 102, a local network, cloud services 114, server clusters 116, process 310, memory 330, etc. From this query, electronic gateway 110 may obtain data representing a document, such as a webpage, a text document, a Word document, a PDF document, etc. In some embodiments, electronic gateway 110 may extract data, such as one or more offer attributes representing an offer, from a document; that is, electronic gateway 110 may scrape the data representing an offer in the document to acquire the data.

As another example, in some embodiments, electronic gateway 110 may provide one or more electronic forms to producer device 104 to acquire the data. The electronic form may be constructed to receive an offer attribute that is related to the offer. In some embodiments, once producer device 104 and/or a producer associated with producer device 104 completes the electronic form, electronic gateway 110 may receive an indication that the form has been completed. In some embodiments, electronic gateway 110 may be configured to process the information from the form or indication, which may contain information associated with the form, to acquire the data.

Electronic gateway 110 may use other techniques to acquire the data, such as acquiring the data from a third-party device and/or producer device 104 via an application programmable interface (API). In some embodiments, the API may be associated with electronic gateway 110. In certain embodiments, the API may be associated with the third-party device, producer device 104, etc. Electronic gateway 110 may acquire the data in a number of ways, which are not limited by the examples provided above.

At step 520, electronic gateway 110 may generate a business context attribute based on an offer attributed included in the data (e.g., producer data). In some embodiments, electronic gateway 110 may extract the offer attribute from the data acquired based on natural language processing of the received data. In some of these embodiments, electronic gateway 110 may have used natural language processing in a different step (e.g., step 510) to extract the offer attribute. After extracting and/or identifying an offer attribute, electronic gateway 110 may generate the business context attribute based on matching the offer attribute to a predefined business context attribute. Electronic gateway 110 may, in some embodiments, determine and/or calculate based on calculating and/or determining the offer attribute based on the predefined business context attribute.

In some embodiments, the business context attribute may be predefined. A business context attribute may give electronic gateway 110 the ability to classify one or more different offer attributes. For example, a business context attribute may be a “total cost” for a good. Thus, in some embodiments, when electronic gateway 110 acquires an offer attribute representing a “cost” and an offer attribute representing a “discount percentage,” electronic gateway 110 may calculate a business context attribute that represents the “total cost” of a good by multiplying the “cost” and the “discount” attributes.

Electronic gateway 110 may have previously defined the business context attribute based on one or more historical characteristics from one or more consumer device(s) 106. In some embodiments, electronic gateway 110 may use a historical offer attribute and/or historical business context attribute to train a machine learning model to generate a business context attribute. For example, using the simple scenario as described above, electronic gateway 110 may predetermine that a business context attribute representing the total cost of a good is needed based on previous scenarios, where electronic gateway 110 acquired offer attribute “cost” and “discount percentage” and/or calculated the “cost” and “discount” attribute to accommodate the characteristics of one or more consumer(s) 106 needing the “total cost of a good.” In some embodiments, the machine learning model may, additionally or alternatively, take into account other historical factors, such as past data acquired from the particular producer device 104, one or more related producer device(s) 104 (and/or associated producers), one or more characteristics from one or more related consumer device(s) 106, the type of producer device(s) 104 (and/or associated producers), time of acquiring offer attribute, date of generating the business context attribute, etc.

At step 530, electronic gateway 110 may generate a data structure. The data structure may be based on the offer attribute and/or business context attribute. In some embodiments, the data structure may include one or more fields. In some embodiments, the fields may correspond to the offer attribute and/or the business context attribute. The fields may represent the values, such as values of the offer attribute, business context attribute, etc. The fields may also contain a field identifier and/or a field name. In some embodiments, the data structure may associate one or more fields (e.g., offer attribute) with one or more other fields (e.g., a generated business context attribute). For example, the data structure may indicate that a field (e.g., an offer attribute) has a one-to-many, one-to-one, many-to-one, many-to-many relationship, etc., with another field (e.g., a business context attribute). The data structure may also concatenate and store, using various methods known in the art, multiple forms of information in a field. For example, the data structure may concatenate an offer attribute and business context attribute and store the encapsulation into a field. In some embodiments, the data structure may include one or more fields corresponding to and/or include one or more identifiers associated a producer device 104, an index, a cost, etc.

At step 540, electronic gateway 110 may generate a cost. The cost may represent the minimum cost of producing the data structure, a field, and/or data associated with the data structure or field (e.g., business context data). Electronic gateway 110 may base the cost on the offer attribute, an attribute weight, a business attribute, a business attribute weight, a producer attribute (e.g., a producer ranking), a producer attribute, etc. The weights of the attribute, in some embodiments, may be predetermined using similar techniques, such as machine learning techniques as described above, in relation to step 520.

In some embodiments, electronic gateway 110 may use a cost function to calculate the cost. The cost function may include one or more function, such as a weighted-average function, a comparison function, a linear regression function, a logical function, etc. In some embodiments, electronic gateway 110 may train a machine learning model using a historical cost associated with information and/or one or more fields in the data structure and calculate the cost based on the machine learning model. For example, electronic gateway 110 may train a machine learning model using a historical cost associated with at least one of a type of offer attribute or a type of the business attribute and calculate the cost based on the machine learning model. In certain embodiments, electronic gateway 110 may use the cost function to train a machine learning model to calculate the cost and calculate the cost based on the machine learning model. Electronic gateway 110 may use other techniques and/or information to generate the cost and is not limited to the techniques as described above.

At step 550, electronic gateway 110 may generate one or more indices for the one or more fields (and/or data structures). The indices may correspond to one or more locations, such as database locations, table locations, document locations, etc. Electronic gateway 110 may generate the indices using known techniques or techniques associated with a particular database and/or database management system. In some embodiments, electronic gateway 110 may generate a different index when preparing to store the data structure and/or one or more fields in the data structure into relational database than an object-oriented database, cloud database, column-oriented database, NoSQL database, etc. In some embodiments, electronic gateway 110 may use one or more costs of a filed and/or the data structure, etc., to generate the one or more indices. For example, electronic gateway 110 may generate an index by comparing the cost generated at step 540 to previously generated costs of related or non-related fields and/or data structures. In some embodiments, the index may be determined to be the costs. Electronic gateway 110 may use other techniques and/or information to generate the index and is not limited to the techniques as described above.

In some embodiments, at step 560, electronic gateway 110 may store (e.g., persist) the data structure and/or one or more fields in the data structure to database 112. Electronic gateway 110 may store the data structure and/or one or more fields to database 112 for future retrieval and/or to update, delete, and/or read stored data later. In some embodiments, at step 570, electronic gateway 110 may publish an event. The event may be associated with the data structure, such as being associated with one or more fields, being stored to, updated in, read from, and/or deleted from database 112. In some embodiments, the data structure may represent an offer. At step 580, electronic gateway 110 may notify one or more consumer device(s) 106 that electronic gateway 110 has published or stored, read, updated, and/or deleted the data structure and/or one or more fields in the data structure.

As stated above, one or more steps may be added or deleted to implement data handling process 500. For example, in some embodiments, data handling process 500 may include steps to determine whether to complete any of steps 520-580 based on determining that the data acquired in step 510 is not suitable for electronic gateway 110. In certain situations, electronic gateway 110 may determine that the acquired data is not suitable because the acquired data relates to, for example, a line of business that is not associated with electronic gateway 110 and/or any consumer device 106 associated with electronic gateway 110 (e.g., a “housing” line of business that is not associated with electronic gateway 110). In some of these situations, electronic gateway 110 may cease operation of one or more steps of FIG. 5 and/or notify producer device 104 that the data is not suitable. Other situations where electronic gateway 110 may determine that the acquired data is not suitable may include situations where the acquired data is formatted incorrectly, the acquired data contains unsecure elements (e.g., such as those associated with database hijacking, phishing, sent from an address deemed to be unsafe, etc.), the producer device 104 is not associated with electronic gateway 110, the producer device 104 is not in a market, line of business, and/or group of merchants that are associated with produce device 104, etc.

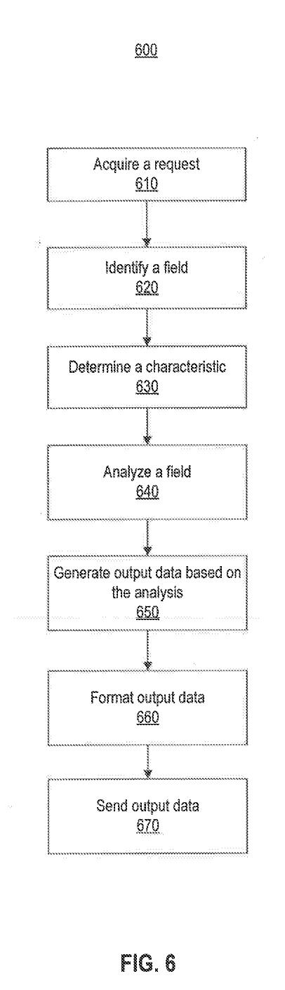

FIG. 6 is a flowchart illustrating an exemplary data consumption process 600 in accordance with the disclosed embodiments. Electronic gateway 110 via electronic line-of-business gateway application 400 may implement one or more steps in the flowchart. However, the steps illustrated in the flowchart are only exemplary. One or more steps may be added or deleted to implement data consumption process 600.

At step 610, electronic gateway 110 may obtain (e.g., acquire) a request to receive data (e.g., consumer data 206a-n). In some embodiments, the request may be associated with a particular line of business. Electronic gateway 110 may determine that the request is associated with a line of business by, for example, identifying information received in the request (e.g., a characteristic, a consumer identifier, etc.), such as comparing a request with one or more past characteristics that were received. In some embodiments, electronic gateway 110 may determine that a request is associated with a line of business by utilizing other techniques either separately or in combination. For instance, electronic gateway 110 may determine that a request is associated with a merchant based on determining the request from a previous interactions with a consumer device 106 and/or a consumer device that is related to consumer device 106, a setting and/or data structure that associates consumer device 106 which may have sent or related consumer device(s) 106 which may have sent the request with a line of business, use a machine learning model trained using data sent via past requests, characteristics, consumer identifiers, etc.

In certain embodiments, electronic gateway 110 receives the request from consumer device 106 and/or a consumer device associated with a particular line of business. As indicated above, electronic gateway 110 may receive the request from consumer device 106 to allow a user of user device 110 interacting with consumer device 106 to complete one or more business transactions for a line of business. That is, consumer device 106 may seek to request data in order to sell a combination of products to the user.

A request may include one or more of a characteristic of the consumer device 106 and/or user associated with a user device 108 using the consumer device 106. Alternatively or additionally, a request may also include one or more of formatting parameters, a consumer device identifier, a user device identifier, a producer device identifier, a predefined business characteristic identifier, etc. Electronic gateway 110 may receive the request via an API.

At step 620, electronic gateway 110 may identify one or more fields (and/or data structures). Electronic gateway 110 may identify one or more fields associated with the line of business. In some embodiments, electronic gateway 110 may query database 112, cloud service 114, service clusters 116, processor 310, memory 330, or the like to identify the one or more fields associated with the particular line of business.

At step 630, electronic gateway 110 may determine one or more characteristics of the request. In some embodiments, electronic gateway 110 may determine the characteristic by reading the request received in step 610 and/or other data sent before or after the request, which may include the characteristic. Additionally or alternatively, electronic gateway 110 may also determine the characteristic based on previous interactions (such as the handling of previous characteristics) with consumer device 106, or based on a defined relationship with consumer device 106. In some embodiments, electronic gateway 110 may also, similar to step 610, determine a characteristic based on determining the characteristic from previous interactions with a consumer device that is related to consumer device 106, a setting and/or field that associates consumer device 106 which may have sent or related consumer device(s) 106 which may have sent the request with a characteristic, use a machine learning model trained using past characteristics, consumer identifiers, etc.

At step 640, electronic gateway 110 may analyze the fields. In some embodiments, electronic gateway 110 may analyze the fields based on the one or more characteristics of consumer device 106. Electronic gateway 110 may, in some embodiments, match the data in the fields to one or more characteristics.

For instance, a consumer device 106 may host a line-of-business application directed to the real estate industry. Consumer device 106 may send a request that includes a characteristic related to a required size of a down payment for a house. In some instances, electronic gateway 110 may analyze fields related to real-estate to find offers related to the size of down payment for a house. From this analysis, electronic gateway 110 may come away with fields related to offers from producers, such as loan companies (who may supply loans for a house), down payment assistance companies (who may assist with a user getting a down payment), private mortgage insurance companies (who may apply mortgage insurance for users whose down payment would not allow them to have enough equity in the house), etc. In some embodiments, the fields may be used to find other fields. For example, using the exemplary companies above, electronic gateway 110 may determine that the field representing the loan company is applicable, and from determining that the field related to the loan company is applicable, electronic gateway 110 may determine that one or more fields related to private mortgage insurers are applicable (because private mortgage may be tied to a lender but not offer by a lender).

In some embodiments, electronic gateway 110 may train a machine learning model to identify when data in the one or more fields would apply to one or more characteristics. Electronic gateway 110 may train the machine learning model based on one or more historical characteristics and/or one or more historical fields. Electronic gateway 110 may use the trained machine learning model to find one or more fields that more than likely satisfy the characteristics obtained in the request. Electronic gateway 110 may use supervisory, semi-supervisory, or any other techniques to train the machine learning model. In some embodiments, the machine learning model may (or any other component of FIG. 4), additionally or alternatively, take into account other historical factors, such as past obtained characteristics, one or more related consumer device(s) 106 (and/or associated consumer), one or more characteristic from one or more related consumer device(s) 106, the type of consumer device(s) 106 (and/or associated consumer), time of obtaining the characteristic, date obtaining the characteristic, etc.

At step 650, electronic gateway 110 may generate output data (e.g., outgoing consumer data) based on the analysis. In some embodiments, the output data may comprise data from one or more fields. In certain embodiments, the output data may comprise data from two or more fields. In these embodiments, electronic gateway 110 may generate the output data based on combining fields associated with two different producer devices 104. Any component of FIG. 4 may, additionally or alternatively, be used to complete steps 640 and 650.

At step 660, electronic gateway 110 may format the output data. Electronic gateway 110 may format the output data based on or according to a formatting parameter. In some embodiments, the formatting parameter may be associated with the consumer device 106. The formatting parameter may be determined in similar ways that a characteristic may be determined as previously described in step 630. A formatting parameter may be anything that relates to how consumer device 106 will display the information, which includes the calculation of information. For example, the formatting parameter may indicate that data that is or is not relevant to mobile devices (e.g., another device), needs to be excluded from the output data, data needs to be converted in a certain way before it is sent to consumer device 106 (e.g., converting conversion from dollars into Bitcoin), data needs to be precalculated before it is sent to consumer device 106, data needs to be converted to a particular technological format before it is sent to consumer device 106 (e.g., JSON, XML, HTML, a call to an API, etc.), or any other ways of formatting data known to those of ordinary skill in the art. At step 670, send the formatted output data to the consumer device 106.

As stated above, one or more steps may be added or deleted to implement data consumption process 600. For example, in some embodiments, the data consumption process 600 may include steps to determine whether to complete any of steps 620-670 based on determining that the request acquired in step 610 is not suitable for electronic gateway 110. In certain situations, electronic gateway 110 may determine that the request is not suitable because the received request is associated with, for example, a line of business (such as “housing”) that is not associated with electronic gateway 110 and/or any producer device 104 associated with electronic gateway 110. In some of these situations, electronic gateway 110 may cease operation of one or more steps of FIG. 6 and/or notify consumer device 106 that the request is not suitable. Other situations where electronic gateway 110 may determine that the received request is not suitable may include situations where the received request is formatted incorrectly, the acquired data contains unsecure elements (e.g., such as those associated with database hijacking, phishing, sent from an address deemed to be unsafe, etc.), the consumer device 106 is not associated with electronic gateway 110, the consumer device 106 is not in a market, line of business, group of merchants that are associated with the consumer device 106, etc.

As another example, additionally or alternatively to obtaining the request to receive data (in step 610), electronic gateway 110 may complete one or more of steps (620-670) identifying that an event associated has been published and/or pushing an event (e.g., as in step 570). Thus, in some embodiments, consumer device 106 may receive automatic output data from electronic gateway 110 without sending a request and/or obtain the request to receive data (in step 610) implicitly.

In any of the above processes, data may be collected to provide analytics for any of the disclosed devices. For example, data may be collected on consumer device 106 and/or user device 108 to inform a producer associated with producer device 104 valuable information, such as how a particular offer is performing. In some embodiments, producer device 104 may adjust an offer (e.g., either manually or automatically) in response to receiving performance information for a particular offer.

As another example, data may be collected on the producer device to provider electronic gateway 110, consumer device 106, and/or user device 110 with valuable information, such as how often producer device 104 updates an offer, how much producer device 104 changes their offer, etc. This information may help electronic gateway 110 manage its resources (e.g., updating information from producer devices 104 who change their information often, etc.) This information may also help consumer device 106 and/or user device 110 to determine when or how long a producer device 104 may offer a good or service and/or a combination of goods or services, for example, at the best price.

Descriptions of the disclosed embodiments are not exhaustive and are not limited to the precise forms or embodiments disclosed. Modifications and adaptations of the embodiments will be apparent from consideration of the specification and practice of the disclosed embodiments. For example, the described implementations include hardware, firmware, and software, but systems and techniques consistent with the present disclosure may be implemented as hardware alone. Additionally, the disclosed embodiments are not limited to the examples discussed herein.

Computer programs based on the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, non-transitory computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application; such examples are to be construed as non-exclusive. Further, the steps of the disclosed methods may be modified in any manner, including by reordering steps or inserting or deleting steps. It is intended, therefore, that the specification and examples be considered as exemplary only, with the true scope and spirit being indicated by the following claims and their full scope of equivalents.

1. A system for providing an electronic line-of-business gateway, the system comprising:
one or more memory devices storing instructions; and
one or more processors configured to execute instructions to perform operations comprising:
acquiring data representing an offer from a producer device associated with a first line-of-business, the data comprising an offer attribute;
determining that the acquired data relates to a second line-of-business based on an analysis of at least one of a market, a line of business or a merchant associated with the offer;
extracting the offer attribute from the data based on natural language processing;
generating a business context attribute based on the extracted offer attribute, wherein the business context attribute enables the electronic line-of-business gateway to classify one or more different offer attributes;
generating a data structure based on the offer attribute and the business context attribute, the data structure having a field;
generating an index for the field;
storing, based on the index, the field into the database; and
providing a notification of the stored field to a consumer device associated with the second line-of-business.

2. The system of claim 1, wherein the field corresponds to at least one of the offer attribute or the business context attribute.

3. The system of claim 1, wherein the field corresponds to the offer attribute and the business context attribute.

4. The system of claim 1, wherein the field corresponds to at least one of the index or a producer device identifier.

5. The system of claim 1, wherein the operations further comprise calculating a cost based on the offer attribute, an attribute weight, and the business context attribute.

6. The system of claim 5, wherein generating the index comprises generating the index based on the cost.

7. The system of claim 1, wherein the operations further comprise calculating a cost based on a cost function.

8. The system of claim 1, wherein the operations further comprise:
selecting a cost function associated with the producer device; and
calculating a cost based on the cost function.

9. The system of claim 1, wherein the operations further comprise:
training a machine learning model using historical cost data associated with at least one of the offer attribute or business context attribute; and
determining the cost based on the machine learning model, the offer attribute, an attribute weight, and the business context attribute.

10. The system of claim 1, wherein the operations further comprise:
training a machine learning model based on a cost function; and
determining a cost based on the machine learning model.

11. The system of claim 1, wherein the operations further comprise:
acquiring, from the producer device, an address associated with the offer;
obtaining data representing a document by querying the address; and
extracting the offer attribute from the document based on scraping the offer attribute from the data representing the document.

12. The system of claim 1, wherein the operations further comprise:
providing, to the producer device, an electronic form, the form being configured to receive the offer attribute related to the offer;
receiving an indication that the electronic form has been completed by the producer device, the indication including data comprising the offer attribute and the offer; and
extracting the offer attribute from the data.

13. The system of claim 1, wherein the operations further comprise acquiring the data representing the offer from at least one of a third-party or an application programmable interface.

14. (canceled)

15. The system of claim 1, wherein the offer is associated with a line of business, and wherein the line of business is associated with the electronic line-of-business gateway.

16. The system of claim 1, wherein the operations further comprise publishing an event associated with the data representing the offer.

17. The system of claim 16, wherein generating the business context attribute comprises generating the business context attribute in response to publishing the event associated with the data representing the offer.

18. The system of claim 16, wherein the operations further comprise notifying a consumer device of the published event.

19. The system of claim 18, wherein notifying the consumer device comprises notifying the consumer device associated with a line of business, wherein the line of business is associated with the electronic payment gateway.

20. The system of claim 18, wherein notifying the consumer device comprises notifying the consumer device comprising a line of business application.
